(19) United States
(12) Patent Application Publication
(10) Pub. No.: US 2022/0252132 A1
(43) Pub. Date: Aug. 11, 2022

(54) TORSIONAL VIBRATION DAMPER HAVING A HELICAL SPRING ASSEMBLY

(71) Applicant: ZF FRIEDRICHSHAFEN AG, Friedrichshafen (DE)

(72) Inventors: Stojan CEGAR, Bergrheinfeld (DE); Johannes MANTEL, Gochsheim (DE); Thomas KRÜGER, Üchtelhausen (DE); Johnathon SHAUM, Northville, MI (US); Erwin WACK, Niederwerrn (DE); Mario KENSY, Hammelburg (DE); Matthias ALBERT, Bergrheinfeld (DE); Branka MUNRO, Northville, MI (US); Christian WICKEL, Wartmannsroth (DE)

(21) Appl. No.: 17/432,268

(22) PCT Filed: Feb. 19, 2020
(86) PCT No.: PCT/EP2020/054274

§ 371 Date: Aug. 19, 2021

(30) Foreign Application Priority Data
Feb. 20, 2019 (DE) 10 2019 202 296.0
Feb. 17, 2020 (DE) 10 2020 201 916.9

(51) Int. Cl. F16F 15/121; F16F 15/12

(52) U.S. Cl. CPC F16F 15/1216; F16F 15/1203; F16F 2238/026; F16F 2236/085; F16F 2226/02

(57) ABSTRACT

Torsional vibration damper for a drivetrain of a motor vehicle, having a primary element rotatable around a rotational axis and a secondary element rotatable relative to the primary element against an energy storage. The energy storage includes a helical compression spring unit. The helical compression spring unit is provided in a spring channel, and the helical compression spring unit includes an outer spring. The outer spring is formed as an arc spring and an inner spring is provided inside of the outer spring and virtually coaxial to the outer spring. The inner spring when disassembled from the helical compression spring unit is formed as a straight helical compression spring. The inner spring has a winding direction that is opposed to a winding direction of the outer spring and the inner spring when installed in the torsional vibration damper, is shorter than the outer spring by a value of x.

### CROSS REFERENCE TO RELATED APPLICATIONS

This is a U.S. national stage of Application No. PCT/EP2020/054274 filed Feb. 19, 2020. Priority is claimed on German Application Nos. DE 10 2019 202 296.0 filed Feb. 20, 2019 and DE 10 2020 201 916.9 filed Feb. 17, 2020 the content of which is incorporated herein by reference.

### BACKGROUND OF THE INVENTION

### 1. Field of the Invention

The present invention is directed to a torsional vibration damper for a drivetrain of a motor vehicle.

### 2. Description of the Related Art

Torsional vibration dampers for a drivetrain of a motor vehicle, for example, a dual mass damper or a dual mass flywheel (DMF), are known. The latter are used, for example, in a drivetrain of a vehicle to damp rotational irregularities introduced by an engine and which can lead to torsional vibrations. The torsional vibration damper mainly comprises a primary element and a secondary element rotatable against an energy storage. The energy storage is mainly formed by helical compression springs. It is further known that the helical compression springs can be formed straight or curved. It is also known to connect two helical compression springs in parallel, one helical compression spring, an inner spring in this instance, being arranged inside of another helical compression spring, an outer spring in this instance. Both helical compression springs are also formed as arc springs, i.e., are pre-curved. This means that the helical compression spring already presents a curved shape before being assembled. However, it is cost-intensive to produce an arc spring.

### SUMMARY OF THE INVENTION

It is the object of one aspect of the present invention to provide a torsional vibration damper that provides at least one helical compression spring unit, and the helical compression spring unit provides at least two helical compression springs that act in parallel and are arranged coaxially, and the helical compression springs are curved in an installed condition, and the helical compression spring unit is inexpensive to produce and functions reliably.

According to one aspect of the invention, a torsional vibration damper for a drivetrain of a motor vehicle comprises a primary element rotatable around a rotational axis (A) and a secondary element rotatable relative to the primary element against an energy storage, the energy storage comprises a helical compression spring unit, and the helical compression spring unit is provided in a spring channel, and the helical compression spring unit comprises an outer spring, the outer spring is formed as an arc spring, and an inner spring is provided inside of the outer spring and virtually coaxial to the outer spring, and the inner spring when disassembled from the helical compression spring unit is formed as a straight helical compression spring, and the inner spring has a winding direction opposed to a winding direction of the outer spring, and the inner spring when installed in the torsional vibration damper is shorter than the outer spring by a value of x. It should be noted that the arc spring is a helical compression spring which is curved, i.e., extends axially along a radius of curvature, in a disassembled condition. A straight helical compression spring is provided inside of this arc spring as inner spring. The outer spring constructed as an arc spring and the inner spring constructed as a straight helical compression spring form the helical compression spring unit. It should further be noted that a straight helical compression spring is less expensive and simpler to produce than an arc spring. Such being the case, production costs can be reduced by using a straight helical compression spring as inner spring. Further features are also crucial for ensuring the reliable functioning of the helical compression spring unit. In this regard, it is noted that the inner spring is formed shorter in this combination of an arc spring as outer spring and a straight helical compression spring as inner spring. It is advantageous that the inner spring is formed shorter by a value x, where the value x is equal to or less than the outer diameter of the outer spring. An advantageous functional reliability can be achieved through this configuration of the helical compression spring unit. It is further noted that the opposed winding direction of the outer spring with respect to the inner spring is advantageous for the reason that the windings of the springs do not catch in one another during operation.

It can further be provided that the inner spring in disassembled condition provides at least a first spring region, a second spring region, and a third spring region in axially staggered manner, the first spring region and third spring region are at the respective ends of the inner spring, and the second spring region is the middle spring region. The first spring region provides a first winding distance, the second spring region provides a second winding distance, and the third spring region provides a third winding distance, the first winding distance and third winding distance being shorter than the second winding distance. Moreover, the first winding distance, the second winding distance or the third winding distance for the respective spring region can extend in a constant or progressive or degressive manner.

It may also be that an outer diameter of the first spring region and of the third spring region of the inner spring decreases toward the respective end of the spring. In so doing, as a result of the so-called retraction of the spring ends and when using a spring plate with a spring plate pin for the inner spring, the inner spring is successfully supported at the spring plate pin by the respective first winding. In this way, the ends of the inner spring can be prevented from contacting the outer spring. However, it is required for this purpose that the spring plate is supported at the spring channel.

As has already been mentioned, the two spring ends of the inner spring can be radially guided by a spring plate in each instance.

However, the inner spring comes in contact with the outer spring at least partially during operation. This may chiefly affect the second spring region of the inner spring, i.e., the middle region, which is pressed outward against the inner winding of the outer spring by centrifugal force and/or also as a result of a compression of the inner spring. In so doing, the inner spring and the outer spring may rub against one another at the points of contact. In order to reduce possible wear in this case, it can be advantageous that the outer spring and/or the inner spring are surface-treated by a hardening process. Wear can be reduced at the points of contact between the inner spring and outer spring as a result of the harder surface. In this connection, a nitriding process can advantageously be used as hardening method.

It can further be provided that at least one of the two spring end tips is located radially outward, or at least virtually radially outward, in the installed condition. This means that the inner spring, when installed in the helical compression spring unit, is in an oriented state in which at least one spring end has the spring end tip facing radially outward or virtually radially outward. In an advantageous configuration, the inner spring is to be formed such that both spring end tips face radially outward or at least virtually radially outward when installed in the helical compression spring unit. Tests have confirmed that the durability of the inner spring can accordingly be improved especially at the spring ends. In this regard, it must be ensured that the spring end tips also face outward or virtually outward during operation and that the inner spring does not rotate around its longitudinal axis during operation. This fastening can be advantageously ensured with the spring plates described previously in that the spring ends are received on the spring plate pin with virtually no clearance.

Further, it can be provided that the helical compression spring unit comprising at least the outer spring and the inner spring has in disassembled condition a radius of curvature, which is virtually identical to, or is identical to, a radius of curvature of the spring channel. This is advantageous because the helical compression spring unit likewise has virtually the radius of curvature of the spring channel in installed condition. Additional stresses on the helical compression spring unit can be reduced in this way.

Further, a distance between the outer diameter of the inner spring and the inner diameter of the outer spring can amount to between 1% and 9% of the outer diameter of the outer spring. This means that a clearance in radial direction between the inner spring and the outer spring is advantageously 1% to 9% of the outer diameter of the outer spring.

### BRIEF DESCRIPTION OF THE DRAWINGS

The invention is described by way of example in the following. The drawings show:

FIG. 1 is a torsional vibration damper according to the invention;

FIG. 2 is a helical compression spring unit;

FIG. 3 is a straight inner spring;

FIG. 4 is a helical compression spring unit with spring plate; and

FIG. 5 is a helical compression spring unit with spring plate.

### DETAILED DESCRIPTION OF THE PRESENTLY PREFERRED EMBODIMENTS

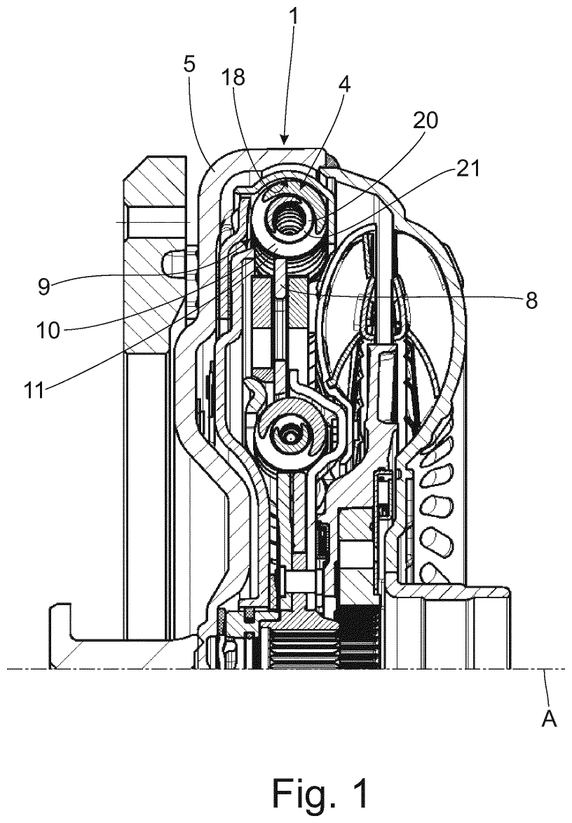

FIG. 1 is a torsional vibration damper 1 according to the invention with a primary element 5 and a secondary element 8. The primary element 5 and the secondary element 8 are rotatable relative to one another against the force of an energy storage 4, in the present instance a helical compression spring unit 9. The helical compression spring unit comprises at least one outer spring 10 and an inner spring 20 provided coaxial to the outer spring. The outer spring 10 is supported radially outwardly at a spring channel 18. The two springs 10, 20 act in parallel. The outer spring is formed in the present instance as an arc spring 11, and the inner spring is formed as a straight helical compression spring 21. It should be noted for the sake of completeness that the arc spring is a helical compression spring that is also curved, i.e., has a radius of curvature, in a disassembled condition. Conversely, the inner spring 20 is formed as a straight helical compression spring, which is more advantageous than an arc spring in terms of production costs.

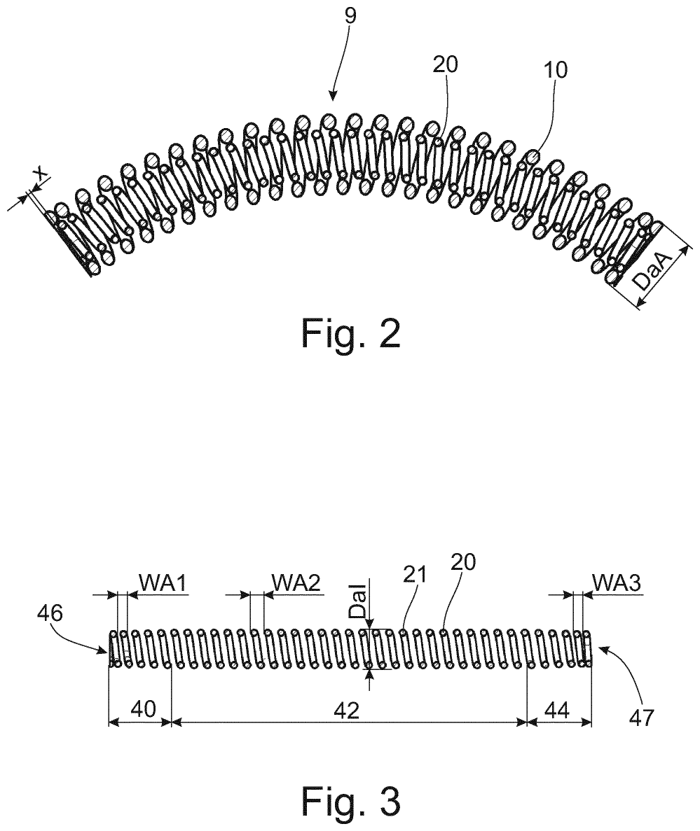

The helical compression spring unit 9 is more readily seen in FIG. 2. In this case, the inner spring 20, which is straight in the uninstalled condition has been inserted into the outer spring 10. It is crucial for reliable functioning that the inner spring 20 is shorter than the outer spring 10. This is because the outer spring 10 can get stuck in the spring channel 18 as a result of the centrifugal force and consequent frictional force, and the inner spring can exit. This can bring about additional bending stresses and can even lead to the two springs 10, 20 getting caught. This exiting or catching effect can be mitigated by an inner spring 20 that is shorter than the outer spring 10, which can also have an advantageous effect on operating reliability and service life. The inner spring is to be formed shorter than the outer spring by a value x. In this regard, it has proven advantageous when the value x is between 1% and 9% of the outer diameter of the outer spring DaA.

The individual inner spring 20 is shown as straight helical compression spring 21 in FIG. 3. It can be seen clearly that the inner spring is divided into a first spring region 40, a second spring region 42, and a third spring region 44. The first spring region 40 and the third spring region 44 are located at the respective spring ends 46, 47, while the second spring region 42 comprises the middle spring region. FIG. 3 clearly shows that a winding distance WA2 extends in a virtually constant manner in the second spring region 42, while winding distance WA1 becomes smaller toward spring end 46 in the first spring region 40. It is the same case with winding distance WA3 at the third spring region 44, which likewise becomes smaller toward spring end 47. It can also be seen clearly here that the outer diameter of the inner spring DaI measured in the second spring region 42 becomes smaller toward spring ends 46, 47 in the area of the first spring region 40 and third spring region 44.

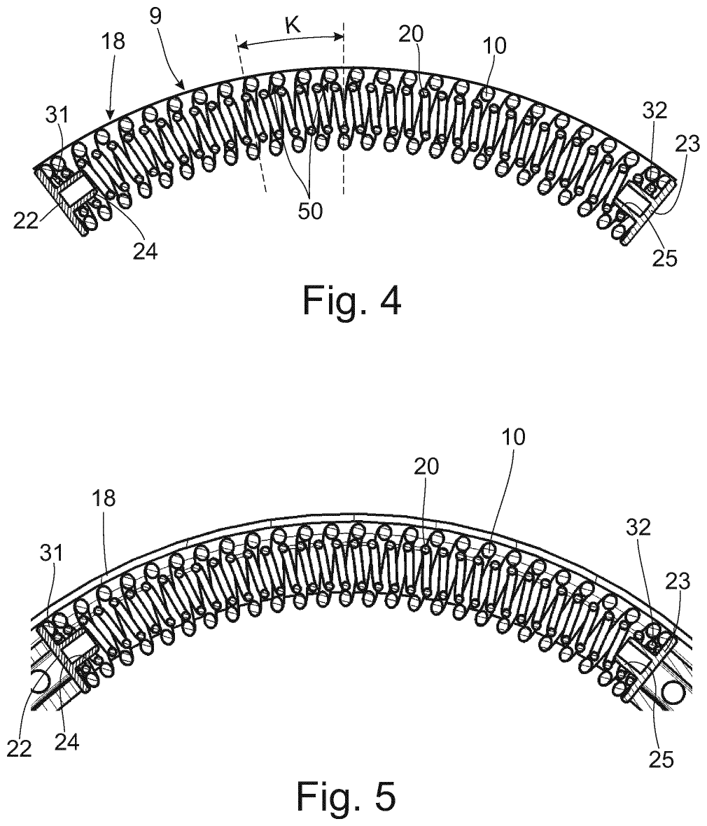

A helical compression spring unit 9 is shown in FIG. 4 and FIG. 5, a spring plate 22, 23 being provided at the respective ends of the helical compression spring 9. Spring plates 22, 23 comprise a spring plate pin 24, 25, respectively, and the spring plate pins 24, 25 engage in the inner diameter of the inner spring 20 and guide the inner spring 20 in radially outward direction. It is understood that the spring plates 22, 23 are supported in turn radially outwardly at the spring channel 18 as can be seen particularly clearly in FIG. 5. The contact area K of inner spring 20 with outer spring 10 is shown clearly in FIG. 4. The contact area K is located in the middle region of the helical compression spring unit 9. The outer windings of the inner spring 20 come in contact with the inner windings of the outer spring 10, and the inner spring 20 is supported radially outwardly at the outer spring 10 in this area K. In case no spring plates are used, it should further be noted that the outer spring 10, while certainly formed as an arc spring 11, may be provided in the disassembled condition with a radius of curvature that is smaller than the radius of curvature of the spring channel 18. When the straight inner spring 20 is inserted into the curved outer spring 10, the radius of curvature of the outer spring 10 increases as a result of the inner spring 20. In this regard, it is advantageous when the radius of curvature of the helical spring unit 9 corresponds to the radius of curvature of the spring channel 8 after the inner spring 20 has been inserted into the outer spring 10. This can reduce further stresses on the springs 10, 20.

It can also be seen clearly in FIG. 4 that the respective spring end tips 31, 32 are directed radially outward. This can reduce further stresses in the inner spring 20 especially during operation.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A torsional vibration damper for a drivetrain of a motor vehicle, comprising:
a primary element rotatable around a rotational axis;
an energy storage that comprises a helical compression spring unit, wherein the helical compression spring unit comprises:
an outer spring formed as an arc spring; and
an inner spring is provided inside of the outer spring and virtually coaxial to the outer spring,
wherein the inner spring when disassembled from the helical compression spring unit is formed as a straight helical compression spring;
a spring channel in which the helical compression spring unit is provided; and
a secondary element rotatable relative to the primary element against the energy storage,
wherein the inner spring has a winding direction which is opposed to a winding direction of the outer spring, and
wherein the inner spring when installed in the torsional vibration damper is shorter than the outer spring by a value of x.

14. The torsional vibration damper according to claim 13,
wherein the value x is less than or equal to an outer diameter of the outer spring.

15. The torsional vibration damper according to claim 13,
wherein the inner spring in disassembled condition provides at least a first spring region, a second spring region, and a third spring region in axially staggered manner, and
wherein the first spring region and the third spring region are at respective ends of the inner spring, and
wherein the second spring region is a middle spring region.

16. The torsional vibration damper according to claim 15,
wherein the first spring region provides a first winding distance, the second spring region provides a second winding distance, and the third spring region provides a third winding distance, and
wherein the first winding distance and the third winding distance are shorter than the second winding distance.

17. The torsional vibration damper according to claim 16, wherein the first winding distance, the second winding distance or the third winding distance extend in one of a constant, progressive, or degressive manner.

18. The torsional vibration damper according to claim 16, wherein an outer diameter of the first spring region and the third spring region of the inner spring decreases toward a respective spring end.

19. The torsional vibration damper according to one of claim 13, wherein each spring end of the inner spring is radially guided by a respective spring plate.

20. The torsional vibration damper according to claim 13, wherein at least one of the outer spring and the inner spring are surface-treated by a hardening process.

21. The torsional vibration damper according to claim 20, wherein the hardening process is a nitriding process.

22. The torsional vibration damper according to claim 13, wherein at least one spring end tip is located radially outward or at least virtually radially outward when installed.

23. The torsional vibration damper according to claim 13, wherein the helical compression spring unit comprising at least the outer spring and the inner spring has in disassembled condition a radius of curvature which is one of virtually identical to or identical to, a radius of curvature of the spring channel.

24. The torsional vibration damper according to claim 13, wherein a distance between an outer diameter of the inner spring and an inner diameter of the outer spring amounts to between 1% and 9% of an outer diameter of the outer spring.
